(19) United States
(12) Patent Application Publication
(10) Pub. No.: US 2016/0098594 A1
(43) Pub. Date: Apr. 7, 2016

(54) ELECTRONIC APPARATUS, PROCESSING METHOD AND STORAGE MEDIUM

(71) Applicant: KABUSHIKI KAISHA TOSHIBA, Tokyo (JP)

(72) Inventor: Chikashi Sugiura, Tokyo (JP)

(21) Appl. No.: 14/662,784

(22) Filed: Mar. 19, 2015

(30) Foreign Application Priority Data
Oct. 1, 2014 (JP) 2014-202901

(51) Int. Cl. G06K 9/00; G06F 3/0488; G06K 9/22; G06F 3/041

(52) U.S. Cl. CPC G06K 9/00422; G06F 3/041; G06F 3/04883; G06K 9/222

(57) ABSTRACT

According to one embodiment, an electronic apparatus includes a receiver and circuitry. The receiver is configured to receive a first image including a handwritten character. The circuitry is configured to generate first stroke data corresponding to the handwritten character from the first image, acquire a first character code of a character including a stroke indicated by the first stroke data, acquire second stroke data corresponding to the first character code through a search using the first character code, and associate the first image and the second stroke data with each other.

### CROSS-REFERENCE TO RELATED APPLICATIONS

This application is based upon and claims the benefit of priority from Japanese Patent Application No. 2014-202901, filed Oct. 1, 2014, the entire contents of which are incorporated herein by reference.

### FIELD

Embodiments described herein relate generally to an electronic apparatus, a processing method, and a storage medium.

### BACKGROUND

Recently, various electronic apparatuses which can be powered by battery and carried easily, such as tablets and smartphones, have become widespread. Most of these electronic apparatuses comprise a touchscreen display to facilitate an input operation by a user.

The user can touch a menu or an object displayed on the touchscreen display by a finger or the like, thereby instructing the electronic apparatus to execute a function associated with the menu or object.

Meanwhile, most of the existing electronic apparatuses provided with such a touchscreen display are consumer products which seek after operability on media data such as images and music, and may not necessarily be suitable for use in business situations, such as a conference, business negotiations, and product development, where document information must be processed. For example, when a character is to be input, an operation by use of a hardware keyboard is often superior to a touch operation. Accordingly, in business situations, a paper pocket notebook is still in use widely.

At the same time, a method of converting a document written on an analog medium such as a piece of paper into digital information has been proposed variously.

For example, when data (stroke data) regarding a stroke of a handwritten character is to be acquired from an image obtained by photographing a document written on an analog medium such as a piece of paper, an error between a stroke of the handwritten character in the image and a stroke which should have been applied to the character in question is large. Thus, when a stroke is displayed based on the acquired stroke data, the user encounters a problem that the displayed stroke looks different from the handwritten stroke in appearance.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment.

FIG. 2 is an exemplary illustration showing an example of a handwritten document on a touchscreen display of the electronic apparatus of the embodiment.

FIG. 3 is an exemplary diagram for explaining time-series information (handwritten page data), which is stored on a storage medium by the electronic apparatus of the embodiment, corresponding to the handwritten document shown in FIG. 2.

FIG. 4 is an exemplary block diagram showing a system configuration of the electronic apparatus of the embodiment.

FIG. 5 is an exemplary block diagram showing a functional configuration of a handwritten note application program which operates on the electronic apparatus of the embodiment.

FIG. 6 is an exemplary flowchart showing procedures of handwritten page creation processing executed by the electronic apparatus of the embodiment.

FIG. 7 is an exemplary diagram showing an example of a code/stroke correspondence table obtained by the handwritten page creation processing shown in FIG. 6.

FIG. 8 is an exemplary first illustration for explaining a principle of processing of associating a document image with time-series information executed by the electronic apparatus of the embodiment.

FIG. 9 is an exemplary second illustration for explaining a principle of processing of associating the document image with the time-series information executed by the electronic apparatus of the embodiment.

FIG. 10 is an exemplary flowchart showing procedures of processing of associating a document image with time-series information executed by the electronic apparatus of the embodiment.

FIG. 11 is an exemplary illustration showing an example of a document image.

FIG. 12 is an exemplary illustration schematically showing an example of the processing of associating the document image with time-series information executed by the electronic apparatus of the embodiment.

FIG. 13 is an exemplary illustration showing an example of a user interface when association cannot be made by the processing of associating the document image with the time-series information executed by the electronic apparatus of the embodiment.

### DETAILED DESCRIPTION

Various embodiments will be described hereinafter with reference to the accompanying drawings.

In general, according to one embodiment, an electronic apparatus comprises a receiver and circuitry. The receiver is configured to receive a first image comprising a handwritten character. The circuitry is configured to generate first stroke data corresponding to the handwritten character from the first image, acquire a first character code of a character comprising a stroke indicated by the first stroke data, acquire second stroke data corresponding to the first character code through a search using the first character code, and associate the first image and the second stroke data with each other.

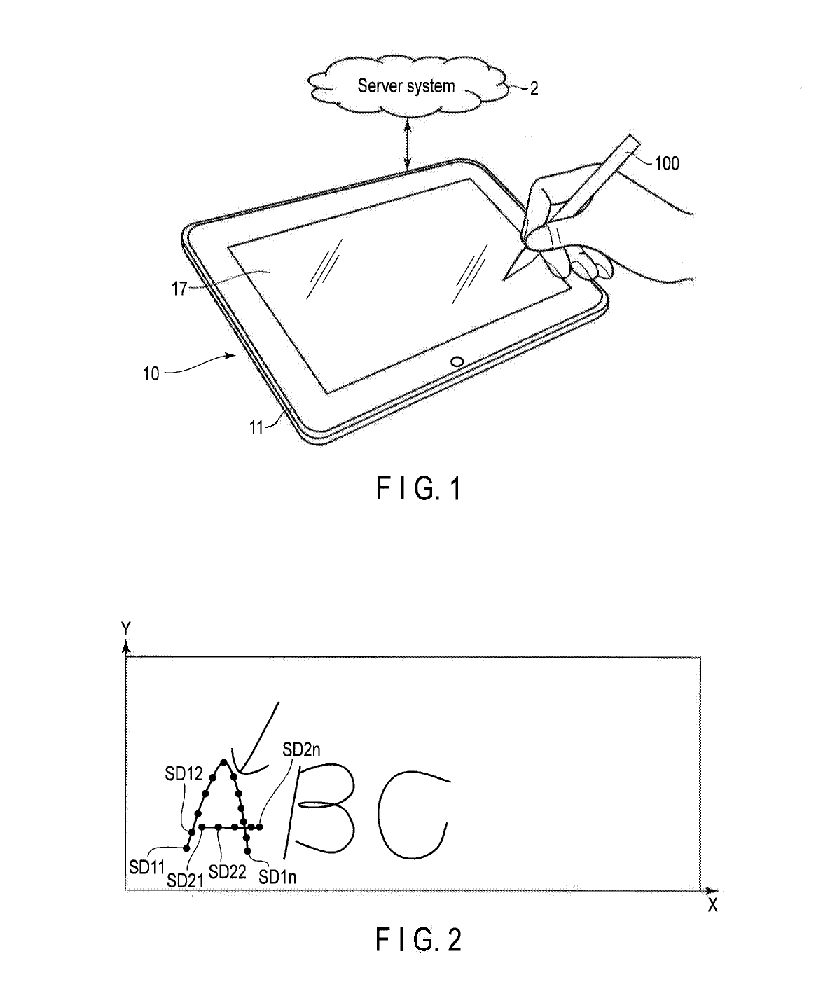

FIG. 1 is an exemplary perspective view showing an appearance of an electronic apparatus according to an embodiment. The electronic apparatus is a pen-based portable electronic apparatus comprising an input module capable of inputting a document written by hand with a stylus (pen) or a finger, for example. The electronic apparatus can store a document handwritten on the receiver not as bitmap image data, but as at least one stroke data representing time series of coordinates of sampling points of a locus of a stroke which constitutes a character, a number, a mark, a figure, etc., which constitutes the document, and search for the handwritten document based on the stroke data. As described above, the electronic apparatus recognizes the corresponding relationship between the stroke data and a symbol (a bitmap image and a trace of handwriting). Since the electronic apparatus can generate a bitmap image from the stroke data based on this corresponding relationship, a part of a document image (a character candidate area) which has been input by use of a scanner or a camera, etc., and the stroke data can be associated with each other. In this way, the electronic apparatus can capture a document written in a paper notebook in the past as stroke data.

Also, the electronic apparatus can perform character recognition processing for a bitmap image represented by a part of the stroke data (partial information corresponding to one symbol area), store the handwritten document as text constituted of a character code, and search for the handwritten document based on the text. As can be seen, the electronic apparatus recognizes the corresponding relationship between at least one of stroke data and the character code. Since the electronic apparatus can generate a bitmap image from a part of the stroke data corresponding to each character code based on this corresponding relationship, a character code of a part of the document image (the character candidate area) which has been input by use of a scanner or a camera, etc. can be obtained. In this way, the electronic apparatus can also capture a document written in a paper notebook in the past as digital text.

The electronic apparatus can be realized as a tablet computer, a notebook personal computer, a smartphone, a PDA, etc. For convenience of explanation, a case where the electronic apparatus is realized as a tablet computer 10 will be described. The tablet computer 10 is a portable electronic apparatus which is also referred to as a tablet or a slate computer. The tablet computer 10 comprises a main body 11 and a touchscreen display 17 which allows a document to be input by handwriting. The touchscreen display 17 is arranged to be laid over a top surface of the main body 11. By touching a screen of the touchscreen display 17 with a stylus or a finger, various operations can be input. On a back surface of the main body 11, a camera which captures an image of the document is provided. As the images can be captured with this camera, not only the image of a document printed or handwritten on a piece of paper, but also an image of a document written on various analog media such as a document, etc., printed or handwritten on a three-dimensional object can be captured.

The main body 11 comprises a thin box-shaped housing. In the touchscreen display 17, a flat-panel display, and a sensor configured to detect a contact position of the stylus or the finger on a screen of the flat-panel display are incorporated. The flat-panel display may be, for example, a liquid crystal display (LCD). As the sensor, a capacitive touch-panel or an electromagnetic induction-type digitizer, for example, can be used. In the following, a case where both of the two types of sensors, i.e., a digitizer and a touch-panel, are incorporated into the touchscreen display 17 will be described.

Each of the digitizer and the touch-panel is provided to cover the screen of the flat-panel display. The touchscreen display 17 can detect not only a touch operation on the screen using a finger, but also a touch operation on the screen using a dedicated stylus (pen) 100. The stylus 100 may be, for example, an electromagnetic induction stylus. A user can perform a handwriting input operation on the touchscreen display 17 by using an external object (the stylus 100 or finger). During the handwriting input operation, a locus of movement of the external object (the stylus 100 or finger) on the screen, that is, a locus of a stroke handwritten by the handwriting input operation, is drawn in real time, and the locus of each stroke is thereby displayed on the screen. A locus of movement of the external object while the external object is in contact with the screen corresponds to one stroke. A set of characters, numbers, marks, figures, etc., which is a set of handwritten strokes constitutes a handwritten document.

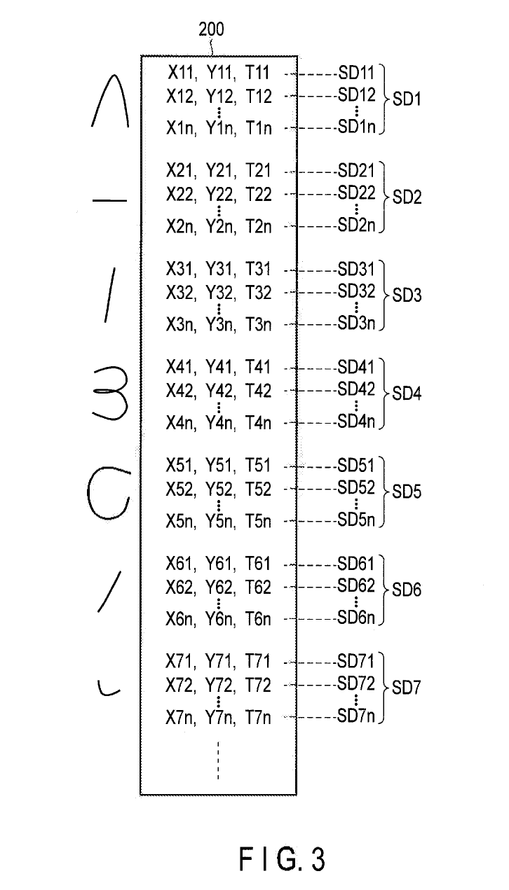

The handwritten document is stored on a storage medium as time-series information indicative of coordinate series of the loci of strokes and the order relation between the strokes. Details of the time-series information will be described later with reference to FIG. 2 and FIG. 3, but the time-series information indicates the order in which the strokes are handwritten and also includes a plurality of stroke data corresponding to the strokes, respectively. In other words, the time-series information is intended as a set of time-series stroke data corresponding to the strokes, respectively. Each stroke data corresponds to one stroke, and includes coordinate data series (time-series coordinates) corresponding to points on the locus of the stroke. The order of arrangement of these stroke data corresponds to the order in which each of the strokes was handwritten, that is the order of strokes.

The tablet computer 10 can read existing arbitrary time-series information from the storage medium, and display a handwritten document corresponding to this time-series information, that is, loci corresponding to strokes indicated by the time-series information respectively, on the screen. Further, the tablet computer 10 comprises an editing function. The editing function can delete or move an arbitrary stroke or an arbitrary handwritten character, etc., in the displayed handwritten document in accordance with an editing operation by the user with an eraser tool, a range specification tool, and various other tools. Also, the editing function includes the function of cancelling a history of several handwriting operations. Further, the editing function can add an arbitrary handwritten character or an arbitrary symbol or the like in the displayed handwritten document.

In the present embodiment, time-series information (a handwritten document) can be managed as data of one page or several pages. In this case, the time series information may be divided into area units which fit in one screen so that a group of time series information which fits in one screen is recorded as one page. Alternatively, the size of the page may be made to be changeable. In this case, since the size of the page can be expanded to be larger than the size of the screen, a handwritten document having an area larger than the size of the screen can be treated as one page. If the entire page cannot be displayed simultaneously on a display, the page may be reduced, or a display target portion within the page may be scrolled up and down or horizontally.

As can be seen, since the time-series information can be managed as page data, the time-series information will be hereinafter referred to as handwritten page data, or simply handwritten data.

The tablet computer 10 comprises a network communication function, and can work in cooperation with other personal computers or a server system 2, etc., on the Internet. That is, the tablet computer 10 comprises a wireless communication device such as a wireless LAN, and can wirelessly communicate with other personal computers. Also, the tablet computer 10 can execute communication with the server system 2 on the Internet. The server system 2 is a system for sharing various kinds of information, and executes online storage service and other various types of cloud computing service. The server system 2 can be realized by at least one server computer.

The server system 2 comprises a high-capacity storage medium such as a hard disk drive (HDD). The tablet computer 10 can transmit the time-series information (handwritten page data) to the server system 2 via a network, and store it on the storage medium of the server system 2 (i.e., upload). In order to ensure secure communication between the tablet computer 10 and the server system 2, when the communication is started, the server system 2 may authenticate the tablet computer 10. In this case, a dialog for prompting the user to input an ID or a password may be displayed on the screen of the tablet computer 10, or alternatively, the ID or like of the tablet computer 10 may be automatically transmitted to the server system 2 from the tablet computer 10.

In this way, even if a capacity of storage inside the tablet computer 10 is small, the tablet computer 10 can deal with many time-series information (handwritten page data) or high-capacity of time-series information (handwritten page data).

Further, the tablet computer 10 can read (download) arbitrary at least one of time-series information (handwritten page data) stored on the storage medium of the server system 2, and display loci of strokes indicated by the read time-series information on the screen of the touchscreen display 17 of the tablet computer 10. In this case, a list of thumbnails (thumbnail images) obtained by reducing pages corresponding to time-series information (handwritten page data), respectively, may be displayed on the screen of the touchscreen display 17, and a page selected from these thumbnails may be displayed on the screen of the touchscreen display 17 in a normal size.

As can be seen, in the present embodiment, the storage medium on which the time-series information is stored may be either the storage inside the tablet computer 10 or that inside the server system 2. The user of the tablet computer 10 can store an arbitrary time-series information in an arbitrary storage selected from the storage inside the tablet computer 10 and the storage inside the server system 2.

Next, with reference to FIG. 2 and FIG. 3, the relationship between strokes (characters, numbers, marks, figures, tables, etc.) handwritten by a user and time-series information will be described. FIG. 2 shows an example of a handwritten document (a handwritten character string) on the touchscreen display 17 by using the stylus 100 or the like.

In the handwritten document, there are quite a number of cases where on top of a handwritten character or figure, etc., another character or figure is handwritten. In FIG. 2, a character string “ABC” is handwritten in the order of “A”, “B”, and “C”, and then an arrow is handwritten very close to the handwritten character “A”.

The handwritten character “A” is represented by two strokes (a locus in the form of “ [symbol] ” and a locus in the form of “−”) which are handwritten by using the stylus 100 or the like, that is, by two loci. The locus of the stylus 100 in the form of “ [symbol] ” which is handwritten first is sampled in real time at regular time intervals, for example. In this way, time-series coordinates SD11, SD12, . . . SD1n of the stroke in the form of “ [symbol] ” are obtained. Similarly, the locus of the stylus 100 in the form of “−” which is handwritten next is also sampled, and time-series coordinates SD21, SD22, . . . SD2n of the “−” form stroke are thereby obtained.

The handwritten character “B” is represented by two strokes which are handwritten by using the stylus 100 or the like, that is, by two loci. The handwritten character “C” is represented by a single stroke which is handwritten by using the stylus 100 or the like, that is, by one locus. The handwritten arrow is represented by two strokes which are handwritten by using the stylus 100 or the like, that is, by two loci.

FIG. 3 illustrates time-series information (handwritten page data) 200 corresponding to the handwritten document of FIG. 2. The time-series information includes a plurality of stroke data SD1, SD2, . . . , SD7. In the time-series information 200, these stroke data SD1, SD2, . . . , SD7 are arranged in the order of trace of handwriting, that is, in the chronological order of strokes handwritten.

In the time-series information 200, the first two stroke data SD1 and SD2 indicate two strokes of the handwritten character “A”, respectively. The third and the fourth stroke data SD3 and SD4 indicate two strokes that constitute the handwritten character “B”, respectively. The fifth stroke data SD5 indicates a single stroke that constitutes the handwritten character “C”. The sixth and the seventh stroke data SD6 and SD7 indicate two strokes that constitute the handwritten arrow, respectively.

Each stroke data includes coordinate data series (time-series coordinates) corresponding to one stroke, that is, a plurality of coordinates corresponding to a plurality of points on a locus of the stroke. In each of the stroke data, the plurality of coordinates are arranged chronologically in the order of strokes written. For example, with respect to the handwritten character “A” stroke data SD1 includes coordinate data series (time-series coordinates) corresponding to the points on the locus of the “ [symbol] ” form stroke of the handwritten character “A”, that is, n coordinate data SD11, SD12, . . . , SD1n. Stroke data SD2 includes coordinate data series corresponding to the points on the locus of the “−” form stroke of the handwritten character “A”, that is, n coordinate data SD21, SD22, . . . , SD2n. The number of coordinate data may be different for each stroke data. Since the coordinate data is sampled at regular periods during the time in which the external object is touching the screen, the number of coordinate data depends on the length of a stroke.

Each coordinate data indicates an X-coordinate and a Y-coordinate corresponding to a certain point in the relevant locus. For example, coordinate data SD11 indicates the X-coordinate (X11) and the Y-coordinate (Y11) of the starting point of the “ [symbol] ” stroke. Further, SD1n indicates the X-coordinate (X1n) and the Y-coordinate (Y1n) of the end point of the “ [symbol] ” stroke.

Also, each coordinate data may include timestamp information T representing the point of time when a point corresponding to the coordinates was handwritten. The point of time at which the point was handwritten may be either an absolute time (for example, year, month, day, hour, minute, and second), or a relative time with reference to a certain point of time. For example, the absolute time (for example, year, month, day, hour, minute, and second) when a stroke was started to be written may be added to each stroke data as timestamp information, and the relative time indicating a difference from the absolute time may be added as timestamp information T to each coordinate data in the stroke data.

As described above, by using the time-series information obtained by adding the timestamp information T to each coordinate data, a temporal relationship between strokes can be more accurately represented. Accordingly, accuracy in performing character recognition of a group formed by one or more strokes which constitutes a character can be enhanced.

Further, information (Z) representing writing pressure may be added to each coordinate data. If the writing pressure is considered, the accuracy for performing character recognition of the group may be further enhanced.

The time-series information 200 having the structure as described with reference to FIG. 3 can represent not only the locus of each stroke, but also the temporal relationship between the strokes. Accordingly, by using the time-series information 200, even if a distal end portion of the handwritten arrow is written to overlap the handwritten character “A”, or written very close to the handwritten character “A”, as shown in FIG. 2, the handwritten character “A” and the distal end portion of the handwritten arrow can be treated as different characters or figures.

As the timestamp information of stroke data SD1, an arbitrary one selected from a plurality of timestamp information T11 to T1n corresponding to their respective coordinates in stroke data SD1, or an average, etc., of timestamp information T11 to T1n may be used. Similarly, as the timestamp information of stroke data SD2, an arbitrary one selected from a plurality of timestamp information T21 to T2n corresponding to their respective coordinates in stroke data SD2, or an average, etc., of timestamp information T21 to T2n may be used. Further, likewise, as the timestamp information of stroke data SD7, an arbitrary one selected from a plurality of timestamp information T71 to T7n corresponding to their respective coordinates in stroke data SD7, or an average, etc., of timestamp information T71 to T7n may be used.

As described above, in the time-series information 200 of the present embodiment, the arrangement of stroke data SD1, SD2, . . . , SD7 indicates the order of strokes of the handwritten characters. For example, the arrangement of stroke data SD1 and SD2 indicates that the stroke in the form of “ [symbol] ” is handwritten first, and the stroke in the form of “−” is handwritten next. Accordingly, even if the two handwritten characters are similar to each other in the look of handwriting, if the orders of strokes in these two handwritten characters are different, they can be distinguished from each other as being different characters.

Also, in the present embodiment, as described above, a handwritten document is stored as the time-series information 200 which is constituted of a set of time-series stroke data corresponding to strokes. Therefore, it is possible to deal with a handwritten character irrespective of a language of the handwritten character. Thus, the structure of the time-series information 200 of the present embodiment can be used in common in various countries all over the world where different languages are used.

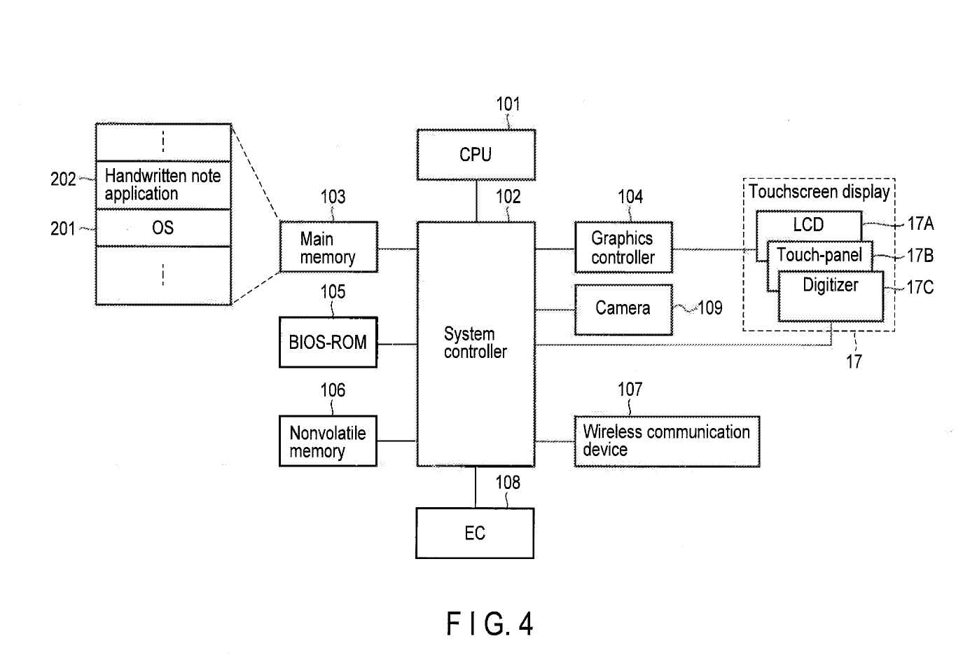

FIG. 4 is an exemplary diagram showing a system configuration of the tablet computer 10.

As shown in FIG. 4, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, a camera 109, etc.

The CPU 101 is a processor for controlling the operation of various components in the tablet computer 10. The CPU 101 executes various kinds of software loaded into the main memory 103 from the nonvolatile memory 106, which is a storage device. These kinds of software include an operating system (OS) 201, and various application programs. The application programs include a handwritten note application program 202. The handwritten note application program 202 includes the aforementioned function of creating and displaying the handwritten page data, the function of editing the handwritten page data, a handwriting (stroke) search function, a character recognition function, a document input function, etc. The document input function is the function of inputting a document image read by a scanner or a camera as time-series information or text, and details of this function will be described later.

The CPU 101 also executes a Basic Input/Output System (BIOS) stored in the BIOS-ROM 105. The BIOS is a program for controlling hardware.

The system controller 102 is a device connecting between a local bus of the CPU 101 and various components. In the system controller 102, a memory controller for access controlling the main memory 103 is integrated. Also, the system controller 102 comprises the function of executing communication with the graphics controller 104 via a serial bus conforming to the PCI EXPRESS standard.

The graphics controller 104 is a display controller for controlling an LCD 17A to be used as a display monitor of the tablet computer 10. A display signal generated by the graphics controller 104 is transmitted to the LCD 17A. The LCD 17A displays a screen image based on the display signal. On the LCD 17A, a touch-panel 17B and a digitizer 17C are arranged. The touch-panel 17B is a capacitive pointing device for inputting data on a screen of the LCD 17A. A contact position on the screen touched by a finger and movement and the like of the contact position are detected by the touch-panel 17B. The digitizer 17C is an electromagnetic induction-type pointing device for inputting data on the screen of the LCD 17A. A contact position on the screen touched by the stylus 100 and movement and the like of the contact position are detected by the digitizer 17C.

The wireless communication device 107 is a device configured to execute wireless communication such as a wireless LAN or 3G mobile communication. The EC 108 is a single-chip microcomputer including a controller for power management. The EC 108 comprises the function of powering the tablet computer 10 on or off in accordance with an operation of a power button by the user.

The camera 109 is provided on a back surface of the main body, and takes a picture of a document handwritten or printed on an analog medium such as a piece of paper. Image data of the photographed document is taken in into the tablet computer 10 as the time-series information or text information by the document input function of the handwritten note application program 202. However, unlike the case where a document is handwritten on the touchscreen display 17, the order of strokes cannot be determined. Therefore, time-series information in which the stroke data is arranged in the order of strokes handwritten cannot be obtained, but at least one stroke data included in the image data of the document can be obtained.

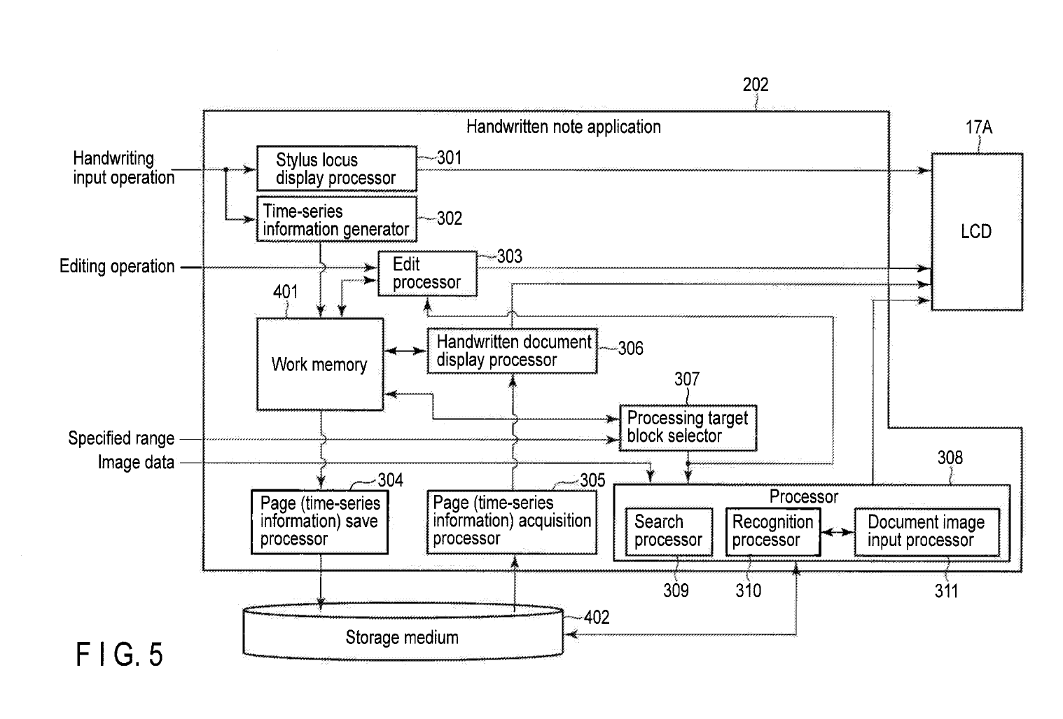

Next, with reference to FIG. 5, a functional configuration of the handwritten note application program 202 will be described.

The handwritten note application program 202 comprises a stylus locus display processor 301, a time-series information generator 302, an edit processor 303, a page save processor 304, a page acquisition processor 305, a handwritten document display processor 306, a processing target block selector 307, a processor 308, etc.

By using the stroke data input with touchscreen display 17, the handwritten note application program 202 creates, displays, edits, and recognizes as a character, for example, the handwritten page data. The handwritten note application program 202 also performs document input processing of converting the image data of a document which has been photographed by the camera 109, read by a scanner not shown, or captured by another apparatus and transmitted from the server system into stroke data or further text data. The touchscreen display 17 is configured to detect an occurrence of an event such as a touch, move (slide), and release. A touch is an event indicating that an external object has touched the screen. A move (slide) is an event indicating that a contact position has changed while the external object remains in contact with the screen. A release is an event indicating that the external object has been lifted from the screen.

The stylus locus display processor 301 and the time-series information generator 302 receive the event of “touch” or “move (slide)” generated by the touchscreen display 17, and thereby detect a handwriting input operation. The “touch” event includes coordinates of the contact position. Similarly, the “move (slide)” event includes coordinates of a contact position of a moving destination. Accordingly, the stylus locus display processor 301 and the time-series information generator 302 can receive coordinate series corresponding to a locus of the movement of the contact position from the touchscreen display 17.

The stylus locus display processor 301 receives the coordinate series from the touchscreen display 17, and displays the locus of each stroke which is handwritten by the handwriting input operation using the stylus 100, etc., on the screen of the LCD 17A in the touchscreen display 17, based on the aforementioned coordinate series. By the stylus locus display processor 301, a locus of the stylus 100 while the stylus 100 is touching the screen, that is, the locus of each stroke, is drawn on the screen of the LCD 17A.

The time-series information generator 302 receives the aforementioned coordinate series output from the touchscreen display 17, and based on the coordinate series, generates the times-series information described above having the structure as described in detail referring to FIG. 3. In this case, the time-series information, that is, the coordinates corresponding to each point of the stroke and the timestamp information may be temporarily stored in a work memory 401.

The page save processor 304 saves the generated time-series information in the storage medium 402 as the handwritten page data. The storage medium 402 is a local database provided in, for example, the nonvolatile memory 106, for storing the handwritten page data. Note that the storage medium 402 may be provided in the server system 2.

The page acquisition processor 305 reads an already-stored arbitrary time-series information (handwritten page data) from the storage medium 402. The read time-series information is transmitted to the handwritten document display processor 306. The handwritten document display processor 306 analyzes the time-series information, and based on a result of this analysis, displays the handwriting, which is loci of strokes indicated by each stroke data in the time-series information, on the screen as a handwritten page.

The edit processor 303 executes processing for editing the handwritten page currently being displayed. That is, the edit processor 303 executes editing processing including the processing of adding a new stroke (a new handwritten character, a new handwritten mark, etc.) to the handwritten page currently being displayed, the processing of deleting or moving one or more strokes within a plurality of strokes displayed, and the like, in accordance with the editing operation and the handwriting input operation performed by the user on the touchscreen display 17. Also, the edit processor 303 updates the time-series information in order to reflect the result of the editing processing in the time-series information being displayed.

The user can use the eraser tool, etc., to delete an arbitrary stroke within the displayed strokes. Also, the user can use the range specification tool to surround an arbitrary portion on the screen with a circle or a box to specify the arbitrary portion in the time-series information (handwritten page) being displayed. In accordance with the specified range on the screen specified by this range specification operation, a time-series information portion to be processed, that is, a stroke data group to be processed, is selected by the processing target block selector 307. In other words, the processing target block selector 307 uses the time-series information being displayed, and selects the time-series information portion to be processed from a first stroke data group corresponding to each of strokes within the specified range.

For example, the processing target block selector 307 extracts the first stroke data group corresponding to each of strokes belonging to the specified range from the displayed time-series information, and determines individual stroke data in the first stroke data group excluding second stroke data which is discontiguous from other stroke data in the first stroke data group as being the time-series information portion to be processed.

The edit processor 303 executes the processing of deletion, movement, etc., of the stroke data group selected by the processing target block selector 307 when a menu such as “delete” or “move” is selected by the user from an edit menu. In this case, when a plurality of stroke data are selected as the stroke data group to be processed, the edit processor 303 can delete these stroke data from the screen as a whole, or move them to a different position on the screen. In the time-series information, time-series coordinates of each of the moved stroke data may be automatically changed according to the moved position. Also, an operation history indicating that the time-series coordinates of each of the moved stroke data have been changed may be added to the time-series information. Each of the deleted stroke data does not necessarily have to be deleted from the time-series coordinates. Alternatively, an operation history indicating that these stroke data have been deleted may be added to the time-series information.

The processor 308 can execute various types of processing, for example, handwriting search processing, character recognition processing, etc., for the time-series information to be processed. The processor 308 includes a search processor 309, a recognition processor 310, and a document image input processor 311.

Further, the processor 308 can associate the time-series information input in the past with the image data of a document input by the camera 109, etc. The processor 308 can further utilize a character recognition result of the time-series information input in the past, and associate text with the input image data. The tablet computer 10 of the present embodiment has the mechanism for accurately associating the input image data and the time-series information input in the past, and this point will be described later. It should be noted that these kinds of processing are performed in cooperation with the recognition processor 310 and the document image input processor 311.

The search processor 309 searches a plurality of time-series information (a plurality of handwritten pages) already stored on the storage medium 402, and finds a specific time-series information portion (a specific handwritten character string, etc.) in these time-series information. The search processor 309 includes a specification module configured to specify the specific time-series information portion as a search key, that is, as a search query. The search processor 309 finds a time-series information portion having a locus of a stroke in which similarity between that locus and a locus of a stroke corresponding to the specific time-series information portion is greater than or equal to a reference value from among the time-series information, reads a handwritten page data containing the found time-series information portion from the storage medium 402, and displays the handwritten page data on the screen of the LCD 17A such that the locus corresponding to the found time-series information portion can be visually distinguished.

For the specific time-series information portion specified as the search query, a specific handwritten character, a specific handwritten character string, a specific handwritten mark, a specific handwritten figure, etc., may be used. For example, one or more strokes themselves which constitute the handwritten object (handwritten characters, handwritten marks, handwritten figures, and the like) which is handwritten on the touchscreen display 17 can be used as the search key.

The search processing executed by the search processor 309 is a handwriting search, and the search processor 309 searches for a handwritten character string having the trace of handwriting which is similar to the specific handwritten character string, which is the search query, from handwritten pages which are already recorded. Note that the handwriting search can be performed on only a certain handwritten page which is currently being displayed.

The search processor 309 searches for a handwritten page including a stroke having a feature similar to that of one or more strokes, which are the search keys, from the storage medium 402. As the feature of each stroke, a direction of a stroke, a shape, an inclination, etc., may be used. In this case, handwritten page data (a handwritten page having a hit) including a handwritten character in which similarity between a stroke of that handwritten character and a search key stroke is greater than or equal to a reference value is searched for from the storage medium 402. As a method of calculating the similarity between the handwritten characters, various methods can be used. For example, coordinate series of each stroke may be treated as a vector. In this case, in order to calculate the similarity between the vectors to be compared, the inner product of these vectors may be calculated to determine the similarity between these vectors to be compared. Also, as another example, loci of strokes may be treated as images, respectively, to calculate the size of an area having the most overlapping portion in the images of the loci to be compared as the aforementioned similarity. Further, an arbitrary way of reducing a calculation throughput may be devised. Also, as a method of calculating similarity between handwritten characters, dynamic programming (DP) may be used.

As can be seen, since the stroke data is used as the search key instead of a code group representing character strings, searches which do not depend on languages can be carried out.

It should be noted that the search processing can be performed for not only the handwritten page data group in the storage medium 402, but also the handwritten page data group stored on the storage medium of the server system 2. In this case, the search processor 309 transmits a search request including one or more stroke data corresponding to one or more strokes to be used as the search key to the server system 2. The server system 2 searches for handwritten page data (a handwritten page having a hit) having a feature similar to that of one or more stroke data from the storage medium, and transmits this handwritten page having the hit to the tablet computer 10.

The aforementioned specification module in the search processor 309 may display a search key input area for handwriting the character string or figure to be searched for on the screen. The character string, etc., which is handwritten in the search key input area by the user is used as the search query.

Alternatively, as the specification module, the aforementioned processing target block selector 307 may be used. In this case, the processing target block selector 307 can select the specific time-series information portion in the displayed time-series information as the character string or figure, etc., of the target of the search in accordance with the range specification operation performed by the user. The user can specify the range in such a way that a part of the character strings in the displayed page is surrounded, or perform the range specification by newly handwriting a character string for search query in the blank space or the like of the displayed page and surrounding this character string for search query.

For example, the user can specify the range by surrounding a portion within the displayed page by a handwritten circle. Alternatively, the user can use a menu prepared in advance to set the handwritten note application program 202 in the “select” mode, and trace a portion within the displayed page with the stylus 100 thereafter.

When the time-series information portion (the handwritten character string) within the displayed time-series information (the handwritten page) is selected as the search query, the search processor 309 excludes the time-series information portion selected as the search query from the target of search. That is, the search processor 309 finds out the time-series information portion having a locus of a stroke in which the similarity with a locus of a stroke corresponding to the selected time-series information portion is greater than or equal to the reference value not from the entire time-series information being displayed, but from other time-series information portions in the displayed time-series information excluding the selected time-series information portion.

As can be seen, by performing the processing of excluding the time-series information portion which has been selected as the search query from the target of search, it is possible to prevent the selected time-series information portion (the character string which should naturally be retrieved) itself from being displayed as a result of the search.

Accordingly, the user can newly handwrite the character string to be used as a search query on the displayed page, and by performing the operation to select this character string, input of the search query is enabled. In this case, since the newly handwritten character string (search query) itself is excluded from the target of search, the newly handwritten character itself will not be displayed as the result of the search. Accordingly, a part of the handwritten page being displayed can be easily used as the search query without displaying the search key input area on the screen.

As can be seen, in the present embodiment, a handwritten character similar to the feature of a certain handwritten character, which has been selected as the search query, can be searched for from the handwritten pages which have already been recorded. Accordingly, it is possible to easily search for a handwritten page which suits the user's intention from many handwritten pages which were created and saved in the past.

In the handwriting search of the present embodiment, unlike the case of a text search, there is no need to perform the character recognition. Accordingly, since the search does not depend on a language, a handwritten page in all languages can be subjected to the search. Also, strokes for a mark, a figure, etc., other than those used for language can be used as the search query for the handwriting search.

The recognition processor 310 executes the character recognition with respect to the time-series information (the handwritten page). The recognition processor 310 performs the character recognition of each of a plurality of blocks (handwritten blocks) which can be obtained by the processing of grouping one or more stroke data represented by the time-series information for which recognition processing should be performed, and converts each of the handwritten characters in these blocks into a character code. Since the time-series information includes information on the order of strokes, timestamp information, and in some cases, writing pressure, apart from information on handwriting (a bitmap image), accuracy of recognition is high. By the grouping processing, one or more stroke data represented by the time-series information for which the recognition processing should be performed are grouped such that the stroke data corresponding to strokes which are located near each other and handwritten continuously, respectively, are classified as the same block.

In this way, a character code for each of the groups corresponding to characters can be obtained from the time-series information. When the character codes are arranged based on the arrangement of the groups, text data of handwritten page data of one page long can be obtained, and the two are associated with each other and stored on the storage medium 402. When character codes are obtained by the recognition processor 310, a code/stroke correspondence table in which the group of the time-series information is associated with each of the character codes is obtained, and this correspondence table is also stored on the storage medium 402. The correspondence table is used for converting a set of stroke data into text data after those stroke data are associated with the input document.

The document image input processor 311 performs the processing of converting the image data of a document which has been photographed by the camera 109 and read by a scanner not shown, or captured by another apparatus and transmitted from the server system 2 into a set of stroke data in cooperation with the recognition processor 310. More specifically, the processing of associating the image data with the time-series information input in the past, which will be described later, is performed.

In the present embodiment, since a character code is obtained from time-series information indicative of a trace of handwriting of a person himself/herself in which the order of strokes is also considered, the accuracy of the character recognition is high. In the conventional optical character recognition (OCR), character codes are obtained by matching of image information. However, reference images of the OCR are not user-specific image data, but are standard images. Therefore, the accuracy of character recognition is decreased as compared to that in the present embodiment.

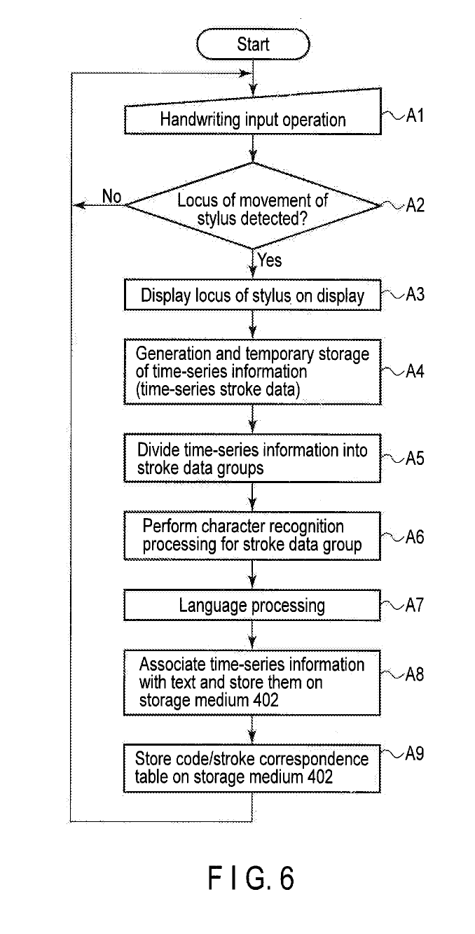

Here, by referring to the flowchart of FIG. 6, procedures of handwritten page creation processing executed by the handwritten note application program 202 will be described.

When the user uses the stylus 100 and performs the handwriting input operation (block A1), the events “touch” and “move” are triggered. Based on these events, the handwritten note application program 202 detects a locus of the movement of the stylus 100 (block A2). When a locus of the movement of the stylus 100 is detected (YES in block A2), the handwritten note application program 202 displays the locus of the movement of the stylus 100 which has been detected on the display (block A3). Further, the handwritten note application program 202 generates the aforementioned time-series information as shown in FIG. 3 based on the coordinate series corresponding to the loci of the movement of the stylus 100 which have been detected, and temporarily saves the time-series information in the work memory 401 as handwritten page information (block A4).

Next, the handwritten page information in the work memory 401 is handed over to the recognition processor 310, and handwritten character recognition processing is performed. First of all, in block A5, stroke data in the time-series information are divided such that stroke data corresponding to strokes which are located near each other and handwritten continuously, respectively, are classified as the same group. The group corresponds to one symbol and constituted of one or more stroke data. In the example of FIG. 3, stroke data SD1 and SD2 are classified as one group, stroke data SD3 and SD4 are classified as another group, and stroke data SD5 is classified as yet another group. In block A6, character recognition processing is performed for one group, and a candidate character is determined. In block A7, language processing is performed and determination of a feasible character string from a linguistic viewpoint is carried out. For example, when “ [symbol] ” (which is a nonexistent term in Japanese) was given as a candidate, since the character string does not make sense, “ [symbol] ” is changed to “ [symbol] ” which is similar in form, and “ [symbol] ” (meaning “text” in Japanese) is presented as a recognition result. In this way, the time-series information of a document input by handwriting and a character code string (text) can be obtained. Also, if necessary, the processing returns to block A5, and the recognition processing is repeated by changing the grouping of the stroke data.

In block A8, text which is constituted of character code strings obtained as a result of the character recognition and the time-series information (FIG. 3) are associated with each other, and stored on the storage medium 402 page by page. The text corresponding to the time-series information of FIG. 3 is (2341, 2342, 2343, 222d, . . . ) (hexadecimal). In this way, the tablet computer 10 can capture the document input by handwriting as text as well.

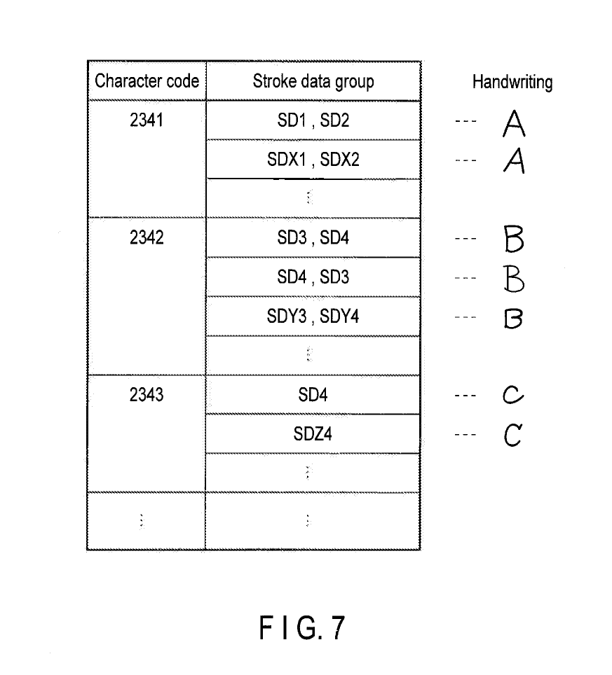

By this processing, the corresponding relationship between the character code and one or more stroke data for each group is obtained, and a code/stroke correspondence table in which a plurality of groups each representing the relationship between one symbol and one or more stroke data are stored is prepared. The code/stroke correspondence table is stored on the storage medium 402 in block A9. An example of the code/stroke correspondence table is shown in FIG. 7. The code/stroke correspondence table may have groups for each of the character codes. It is sufficient if the code/stroke correspondence table and the stroke data included in the groups have information which can display the strokes. For example, they may be one obtained by excluding the order of strokes, the timestamp information, and the writing pressure from the time-series information. Note that in some cases, since the same person may write the same character in a different form of writing, different groups may be associated with one character code. Further, even if the writing is made by the same person or the writing looks the same, the writing may be made in a different stroke order. Therefore, a group which is formed of the same set of stroke data but has different stroke orders may be associated. The code/stroke correspondence table in the storage medium 402 is added and updated every time a new handwritten page is created.

Next, the principle of associating the image data (a character image) of a document which is input by the camera 109, etc., and the time-series information which was input in the past, which is executed by the handwritten note application program 202, will be described.

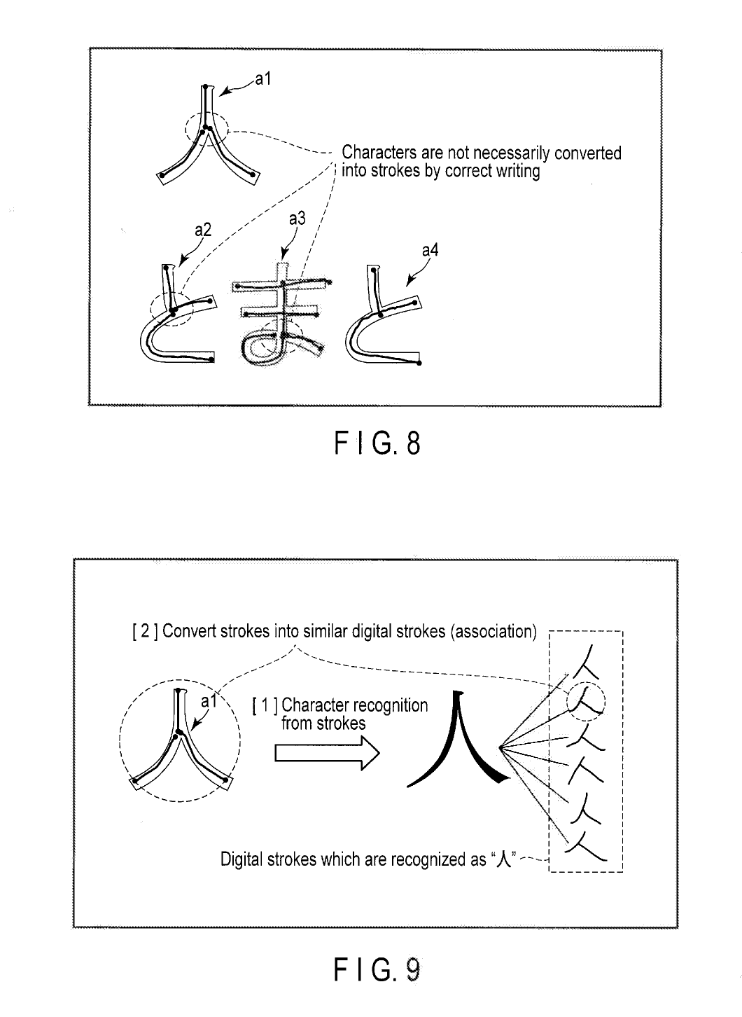

Now, it is assumed that image data of a document including handwritten character “ [symbol] ” (a1) (the term meaning “human” in Japanese) and handwritten character string “ [symbol] ” (a2, a3, a4) (the term meaning “tomato” in Japanese) are handwritten is input, as shown in FIG. 8. In FIG. 8, outline characters represent handwritten characters included in the image data.

The document image input processor 311 analyzes this image data and estimates the strokes of the handwritten characters. Here, this process is referred to as a conversion of the character image into strokes. In FIG. 8, segments of lines within the outline characters represent the estimated strokes. Here, to facilitate the end portions of the strokes to be easily recognized, note that black circles are added at both ends (the starting point and the end point) of the lines for the sake of convenience.

As shown in FIG. 8, as a result of the conversion of the character image into strokes, the recognized strokes are not necessarily consistent with the strokes which should have been applied to the characters in question. For example, the character “ [symbol] ” (a1) should have been constituted of two strokes, but here, the strokes are three. Also, the first character “ [symbol] ” (a2) in the character string “ [symbol] ” (a2, a3, a4) should also have been constituted of two strokes, but here, three strokes are recognized. Note that even in the case of the same character, the character is not always converted into the same number of strokes. For example, in the example of FIG. 8, the third character “ [symbol] ” (a4) in the character string “ [symbol] ” (a2, a3, a4) is converted into two strokes unlike the case of the same character “ [symbol] ” (a2) which appears at the beginning. Further, in the estimated strokes which are obtained by the conversion of the image into strokes, due to the influence of photographing noise, etc., of the character image, the segments of the lines may be more disturbed than those of the strokes which should have been applied to the characters in question. In such a case, when a character is displayed based on such a stroke, a problem that the character looks different from the original handwritten character in appearance, for example, may arise.

Meanwhile, by performing character recognition on the strokes, correct character codes tend to be obtained with a very high degree of accuracy. Focusing on the above point, the handwritten note application program 202 does not associate the character image with the estimated strokes, but performs character recognition with the estimated strokes and obtains the character code, gives a plurality of strokes input in the past which are associated with that character code as candidates, selects the strokes which have the highest degree of resemblance from among those candidates, and associates the character image with the selected strokes, as shown in FIG. 9.

For example, as shown in FIG. 9, the case where the strokes are estimated from the character image “ [symbol] ” (a1) is considered. As described above, in the storage medium 402, a code/stroke correspondence table in which groups of the time-series information are associated with each of the character codes is saved.

The conversion of the character image into strokes is executed by the document image input processor 311. The document image input processor 311 hands over the estimated stroke group to the recognition processor 310. The recognition processor 310 executes the character recognition on the received stroke group, and acquires the character code. For example, even if three strokes are estimated with respect to the character “ [symbol] ” (a1) and they are handed over to the recognition processor 310 from the document image input processor 311, it can be expected that the character “ [symbol] ” will be recognized and the character code corresponding to the character “ [symbol] ” will be acquired. The recognition processor 310 hands over the acquired character code to the document image input processor 311.

The document image input processor 311 searches the code/stroke correspondence table by using the received character code as the search key, and acquires a stroke group associated with that character code. For example, when the character “ [symbol] ” was input by handwriting six times in the past, and six stroke groups are associated with the character code corresponding to this character, the document image input processor 311 generates images of handwriting for all of the six stroke groups, respectively, and compares each of these images of handwriting with the character image. The document image input processor 311 selects a stroke group having the highest degree of resemblance, and in place of the stroke group which has been estimated previously, the selected stroke group is associated with the character image.

In this way, the strokes of the character in the character image can be changed to those which are more close to the original handwritten character in their look when they are displayed than the strokes which are estimated from the character image, and whose stroke count is also correct.

It should be noted that while FIG. 9 illustrates an example of one character, searches of stroke groups based on, for example, character codes used as the search key may be carried out in units of characters such as a term. For example, this can be realized by making the code/stroke correspondence table conform to both of character codes of a single character and a plurality of characters. In this case, the search is not carried out for only the term which matches exactly, but can be carried out with ambiguity to include a partial match. (For example, if a search is carried out by five characters, ones which match by three characters or more are considered to be satisfactory.) In this way, even if a character recognition error is included, an advantage of recovering the error can be expected. For example, in an extreme case, even if the second character “ [symbol] ” (a3) in the character string “ [symbol] ” (a2, a3, a4) shown in FIG. 8 is erroneously recognized as “ [symbol] ”, a search with the character code corresponding to “ [symbol] ” (which is a nonexistent term in Japanese) used as the search key will not have a hit, but this erroneous recognition is resolved as “ [symbol] ” is ambiguously searched.

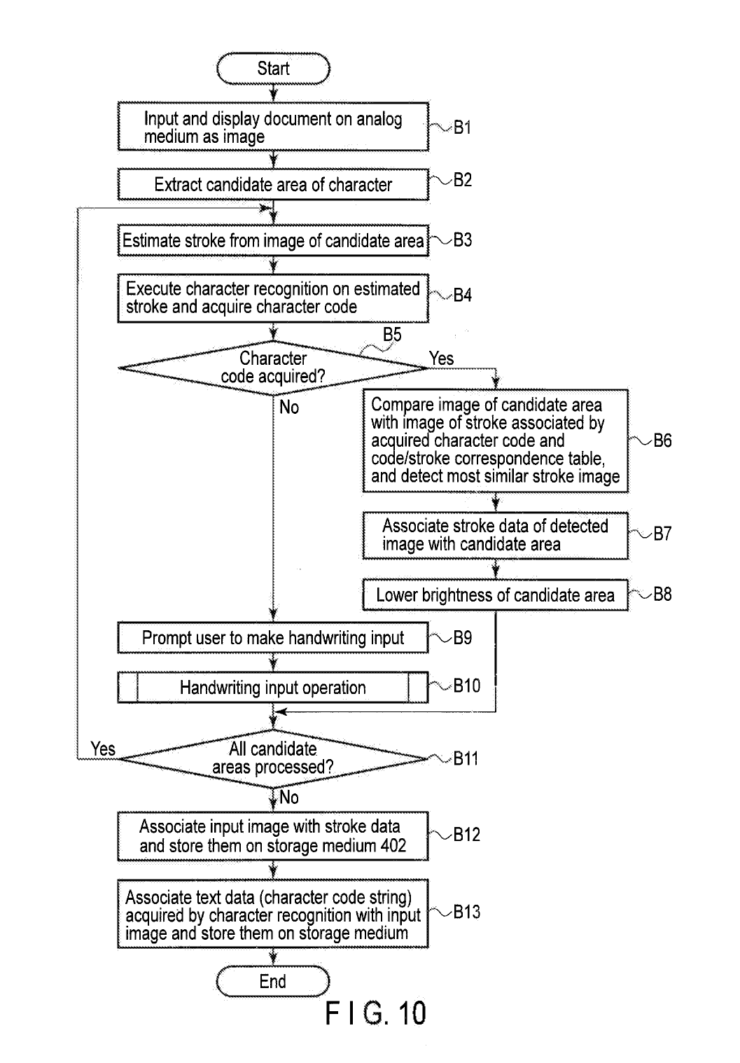

FIG. 10 shows procedures of processing of associating the document image with the time-series information executed by the handwritten note application program 202.

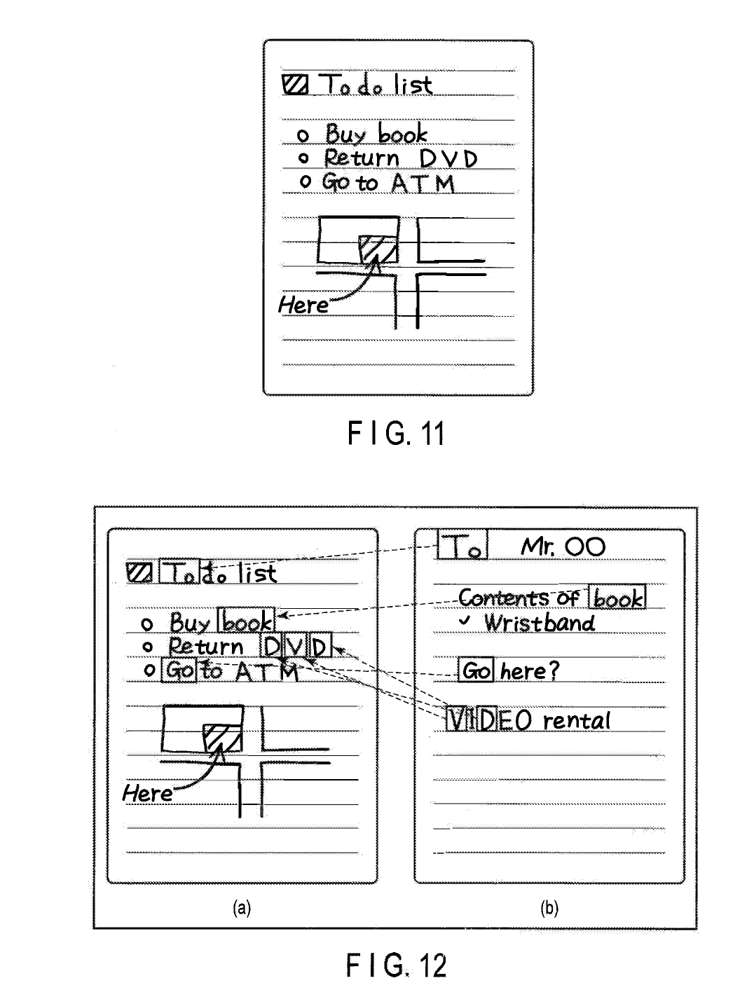

In block B1, a document on an analog medium is input as an image by use of a scanner or the camera 109, etc. Examples of such a document are a document written in a notebook in the past or a document written on a blackboard. The input image is displayed on the touchscreen display 17. FIG. 11 shows a display example of the input image.

In block B2, a line structure of the character in the image is analyzed, and a candidate area of one character (or a radical) which is a part of the image is extracted.

In block B3, a conversion of the character image into strokes based on which the strokes are estimated from the image of the extracted candidate area is executed by the document image input processor 311. Further, in block B4, character recognition on the estimated strokes is executed by the recognition processor 310, and a character code is obtained.

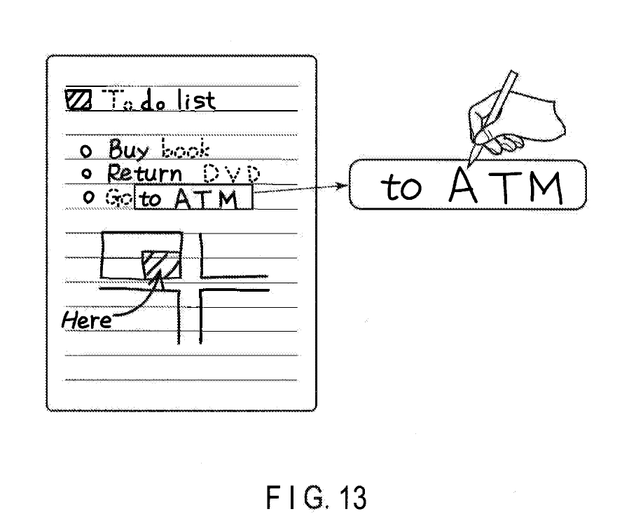

In block B5, whether the character code is acquired is determined, and if the character code is acquired, the processing continues to block B6. In block B6, the document image input processor 311 generates stroke images (images of handwriting) based on the stroke data of each group of the code/stroke correspondence table of FIG. 7, compares the partial image of the candidate area extracted in block B2 with the stroke images, and detects a stroke image similar to the image of the candidate area. Next, in block B7, the document image input processor 311 associates the group of that stroke image with the candidate area. FIG. 12 schematically shows this association. (a) of FIG. 12 shows the input image illustrated in FIG. 11. (b) of FIG. 12 shows a stroke image represented by the time-series information of one page long stored on the storage medium 402. Broken lines between (a) of FIG. 12 and (b) of FIG. 12 show the association. Although (b) of FIG. 12 only shows one page, a similar stroke image is not necessarily obtained from the time-series information on the same page. That is, a similar image is often found from a stroke data image in time-series information on a different page for each candidate area. The way for displaying the candidate area with which the group is associated can be changed such that it can be distinguished from other areas. For example, as shown in FIG. 13, brightness of each image of the candidate area to which the group is associated is lowered.

Meanwhile, when the character code is not acquired, in block B9, the user is prompted to input the stroke data of that candidate area by handwriting. As described with respect to block B8, since the brightness of the image of the candidate area for which a recognition result is obtained is lowered, it is considered that the candidate areas whose brightness has not changed indicate that they are subject to a handwriting input operation. To more emphasize these areas, the display may be flashed, a box may be drawn around the area, or a voice message may be issued.

If the user uses the stylus 100 to trace an image of a candidate area on the touchscreen display 17, in block B10, the handwriting input operation shown in FIG. 6 is performed. The handwriting input may be performed for an image which does not have a character code, that is, a map image in FIG. 13, for example, other than for characters, numbers, and marks. In block B11, it is determined whether the processing of all of the candidate areas is completed, and if the processing is not completed, the processing returns to block B3.

In this way, stroke data (excluding the timestamp information) with respect to the image of the document can be obtained, and in block B12, the input image and the corresponding stroke data are associated with each other and stored on the storage medium 402. Since the stroke data is obtained and an image can be restored from the stroke data, the input image is not necessarily stored.

By the above processing, a document written in a paper notebook or the like in the past can be captured into the tablet computer 10 as stroke data (although the timestamp information is excluded) just like a document handwritten on the touchscreen display 17 by the user using the stylus 100.

Further, by using a result of the character recognition by the recognition processor 310, the input image can be captured into the tablet computer 10 as text (block B13).

As described above, according to the embodiment, a document input to the touchscreen display 17 can be stored on the storage medium 402 as stroke data each representing a handwritten locus. Further, a candidate area of a character can be extracted from a document input as the image by a camera or a scanner, etc., and associated with the stroke data already input by handwriting. In this way, a document written in, for example, a paper notebook by hand can be stored on the storage medium 402 as stroke data just like a document handwritten on the touchscreen display 17.

Further, if character codes are obtained by performing the character recognition processing on the stroke data of a document input to the touchscreen display 17 by handwriting in advance, the document input as an image can be converted into text. Since the stroke data is information specific for each user, accuracy of character recognition is high as compared to the conventional OCR which is based on image matching with reference images. Further, by adding information on the order of strokes, timestamp information, and writing pressure, etc., to the stroke data, the accuracy of recognition can be further enhanced.

In the present embodiment, although all of the processing has been carried out by the tablet computer 10, processing other than making handwriting on the touchscreen display 17 may be carried out by the server system 2. For example, the function of the processor 308 of the handwritten note application program 202 may be transferred to the server system 2. Also, data, etc., may be stored in a database of the server system 2, instead of storing it on the storage medium 402. In this case, a code/stroke correspondence table may be managed for each user, or stroke data of all users may be associated with each character code for all users in common. Alternatively, a code/stroke correspondence table may be managed for each similar category (male/female, child/adult, nationality for alphabets, etc.).

Note that each of various functions described in the present embodiment may be realized by a processing circuit. Examples of the processing circuit include a programmed processor such as a central processing unit (CPU). The processor executes each of the described functions by executing a program stored in a memory. The processor may be a microprocessor including circuitry. Examples of the processing circuit include a digital signal processor (DSP), application specific integrated circuits (ASIC), a microcontroller, a controller, and other electric circuit components.

Since various types of processing of the present embodiment can be realized by a computer program, it is possible to easily realize an advantage similar to that of the present embodiment by simply installing a computer program on an ordinary computer by way of a computer-readable storage medium having stored thereon the computer program, and executing this computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver configured to receive a first image comprising a handwritten character; and
circuitry configured to:
generate first stroke data corresponding to the handwritten character from the first image;
acquire a first character code of a character comprising a stroke indicated by the first stroke data;
acquire second stroke data corresponding to the first character code through a search using the first character code; and
associate the first image and the second stroke data with each other.

2. The apparatus of claim 1, wherein the circuitry is configured to acquire the first character code by character recognition processing on the first stroke data.

3. The apparatus of claim 1, wherein the circuitry is configured to compare the first image with a plurality of second images generated from a plurality of second stroke data when the plurality of second stroke data correspond to the first character code, and to select one second stroke data from the plurality of second stroke data based on a degree of similarity.

4. The apparatus of claim 1, wherein the circuitry is configured to acquire a plurality of second stroke data corresponding to a plurality of first character codes generated from handwritten characters which are adjacent to each other on the first image through a search using the plurality of first character codes.

5. A method of processing comprising:
receiving a first image comprising a handwritten character;
generating first stroke data corresponding to the handwritten character from the first image;
acquiring a first character code of a character comprising a stroke indicated by the first stroke data;
acquiring second stroke data corresponding to the first character code through a search using the first character code; and
associating the first image and the second stroke data with each other.

6. The method of claim 5, wherein the acquiring the first character code comprises acquiring the first character code by character recognition processing on the first stroke data.

7. The method of claim 5, wherein the acquiring the second stroke data comprises comparing the first image with a plurality of second images generated from a plurality of second stroke data when the second stroke data correspond to the first character code, and selecting one second stroke data from the plurality of second stroke data based on a degree of similarity.

8. The method of claim 5, wherein the acquiring the second stroke data comprises acquiring a plurality of second stroke data corresponding to a plurality of first character codes generated from handwritten characters which are adjacent to each other on the first image through a search using the plurality of first character codes.

9. A computer-readable, non-transitory storage medium having stored thereon a computer program which is executable by a computer comprising a multiuser function, the computer program controlling the computer to function as:
a receiver configured to receive a first image comprising a handwritten character; and
circuitry configured to:
generate first stroke data corresponding to the handwritten character from the first image;
acquire a first character code of a character comprising a stroke indicated by the first stroke data;
acquire second stroke data corresponding to the first character code through a search using the first character code; and
associate the first image and the second stroke data with each other.

10. The medium of claim 9, wherein the circuitry is configured to acquire the first character code by character recognition processing on the first stroke data.

11. The medium of claim 9, wherein the circuitry is configured to compare the first image with a plurality of second images generated from a plurality of second stroke data when the plurality of second stroke data correspond to the first character code, and to select one second stroke data from the plurality of second stroke data based on a degree of similarity.

12. The medium of claim 9, wherein the circuitry is configured to acquire a plurality of second stroke data corresponding to a plurality of first character codes generated from handwritten characters which are adjacent to each other on the first image through a search using the plurality of first character codes.
